(19) United States
(12) Patent Application Publication
(10) Pub. No.: US 2015/0281869 A1
(43) Pub. Date: Oct. 1, 2015

(54) NATIVE WEB-BASED APPLICATION

(71) Applicant: Google Inc., Mountain View, CA (US)

(72) Inventors: Vinod Kumar Ramachandran, Sunnyvale, CA (US); Grace Hua Kloba, Sunnyvale, CA (US)

(73) Assignee: Google Inc., Mountain View, CA (US)

(21) Appl. No.: 14/231,582

(22) Filed: Mar. 31, 2014

(51) Int. Cl. H04W 4/00

(52) U.S. Cl. CPC H04W 4/003; H04W 4/001

(57) ABSTRACT

In one aspect, a method and system is provided for facilitating a native web app, the method including receiving a request from a user at a first mobile device to install a native web application (“app”) providing functionality associated with a web app associated with a uniform resource locator (“URL”) from an app store, the web app providing a set of content displayable by a browser app at a user mobile device, accessing the native web app, the native web app including a manifest file including a set of permissions including a permission for displaying a browser app in full screen mode and a set of instructions including instructions for launching a browser app at the first mobile device in full screen mode using the URL, and installing the native web app on the first mobile device.

### BACKGROUND

An app store offered through a mobile device provides an array of native apps to a user. These native apps may be purchased through the app store and installed at the mobile device. Additionally, various websites accessible through a native browser app, at the mobile device, also provide app functionality similar to a native app, but they are typically developed for the web and thus only accessible through the web browser app.

### SUMMARY

The disclosed subject matter relates to a machine-implemented method including receiving a request from a user at a first mobile device to install a native web application (“app”) from an app store accessible at the first mobile device, the native web app providing functionality associated with a web app associated with a uniform resource locator (“URL”), wherein the web app provides a set of content displayable by a browser app at a user mobile device. The method may further include accessing the native web app, the native web app including a manifest file including a set of permissions, the permissions including a permission for displaying a browser app in full screen mode and a set of instructions including instructions for launching a browser app at the first mobile device in full screen mode using the URL. The method may further include providing the set of permissions for display to the user in response to the request. The method may further include receiving an acceptance of one or more permissions of the set of permissions from the user. The method may further include installing the native web app on the first mobile device in response to receiving the acceptance. Other aspects can be embodied in corresponding systems and apparatus, including computer program products.

The disclosed subject matter also relates to a system including one or more processors and a machine-readable medium comprising instructions stored therein, which when executed by the processors, cause the processors to perform operations comprising receiving a request from a user at a first mobile device to install a native web application (“app”) from an app store accessible at the first mobile device, the app store providing a plurality of native apps for one or more mobile devices, the native web app providing functionality associated with a web app providing a set of content displayable by a browser app. The operations may further include accessing the native web app, the native web app including a manifest file including a set of permissions, the permissions including a permission for displaying a browser app in full screen mode and a set of instructions including instructions for launching a browser app at the first mobile device in full screen mode using a uniform resource locator (“URL”) associated with the web app. The operations may further include providing the set of permissions for display to the user in response to the request. The operations may further include receiving an acceptance of the permission for displaying the browser app in full screen mode. The operations may further include installing the native web app on the first mobile device in response to receiving the acceptance. The operations may further include displaying an icon associated with the native web app on the first mobile device in response to installing the native web app.

The disclosed subject matter also relates to a machine-readable medium including instructions stored therein, which when executed by a machine, cause the machine to perform operations including receiving a request from a user at a first mobile device to install a native web application (“app”) from an app store accessible at the first mobile device, the app store providing a plurality of native apps for one or more mobile devices, the native web app providing functionality associated with a web app providing a set of content displayable by a browser app. The operations may further include accessing the native app, the native web app comprising a manifest file including a set of permissions, the permissions including a permission for displaying a browser app at a mobile device in full screen mode and a set of instructions including instructions for launching a browser app in full screen mode using a uniform resource locator (“URL”) associated with the web app. The operations may further include providing the set of permissions for display to the user in response to the request. The operations may further include installing the native web app on the first mobile device.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for generating a native web application at a mobile device that behaves similar to a native application.

FIG. 2 illustrates a flow diagram of an example process for generating a native web application.

FIG. 3 illustrates a flow diagram of an example process for facilitating installation of a native web application at a user mobile device.

FIG. 4 illustrates a flow diagram of an example process for facilitating launching a native web application at a user mobile device.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

A native application (“native app”) is an application (“app”) for a mobile device (smartphone, tablet, etc.) directly installed onto the device. These apps are usually obtained through an online app store or marketplace (hereinafter generally referred to as “app store”). The native apps are downloaded from the app store and installed on the user mobile device. Web applications (“web apps”) refer to Internet-enabled apps that have specific functionality for mobile devices. Web apps are accessed through the mobile device's web browser, rather than being downloaded and installed on the device.

Native apps provide certain advantages over web apps. For example, native apps are typically more easily discoverable (e.g., through app stores), and because they are developed to act as standalone apps, they usually have a look and feel that is both easy to operate and accessible. Additionally, native apps are able to interface with the mobile device native features, information and hardware, whereas web apps may have only limited access to such native features. In one example, to provide easier access to a web app, the web browser at the mobile device may provide a user with an option to add a shortcut to the website associated with the web app to their main menu (e.g., home screen), such that a link (e.g., a shortcut icon) to the website is placed along with native apps on the user's menu and thus easily accessible.

Native apps are typically developed using platform specific development processes, including a specific platform specific language, standardized software development kits (SDKs), development tools and common user interface elements. On the other hand, web apps are usually written in a language or framework of the developer's choice (e.g., HTML5, CSS3, JavaScript, PHP, Rails, Python). Because native apps and web apps are developed using different technologies, where an app owner wishes to have a native app and web app, the owner will have to develop each app separately using the specific technology for that platform or application type (e.g., native app or web app).

The present disclosure facilitates leveraging the benefits of native apps, with respect to apps developed for the web. Methods and systems are provided for generating a native app based on a web app. An app developer is able to generate a native web-based application (“native web app”) from their existing web app. The native web app includes a very thin layer, made up of a single manifest file and limited code which initiates launching the browser in full screen mode with the URL of an existing web app. The native web app can then be submitted to the app store and run as a native app. The embedded URL is used to launch the native web app by accessing the web browser and launching the web app in full screen mode. In one example, the permissions include a permission to launch the browser application in full screen mode.

This allows the developer to gain the benefits of a standalone app without the added efforts of developing a separate native app. These benefits include discoverability and ranking within the app store not typically available to apps running on the web. Furthermore, the web developer is able to leverage functionalities of native apps, using the manifest file. These functionalities include the ability to declare to serve various intents (e.g., URLs), declare specific permissions, specify a unique title and logo, interface with the native features, information and hardware of the mobile device, etc. Because permissions of the native app are declared within the manifest file, in some implementations, the user experience is enhanced, as the user will not be asked for the permissions each time the native web app launches within the browser.

Once the native web app is generated and submitted to the app store, a user is able to search for and install the native web app. The app will launch as a standalone native web app, which operates as a native app. The native web app will be displayed as a full screen app providing the services, information, and functionality of the website associated with the web app. That is, instead of being rerouted to a browser window to view and/or interact with the URL associated with the native web app, the user is presented with a full screen app and may interact with the app independent from a browser window of the browser app.

According to one or more implementations, the native web app is treated as a standalone app running at the mobile device. Accordingly, when the native web app is running, it will be presented as a standalone app within the list of running apps independent from the browser app running at the mobile device. In some examples, the app will be displayed using the unique title and/or logo assigned to the app within the manifest file.

Accordingly, a native web app may be developed from an existing web app.

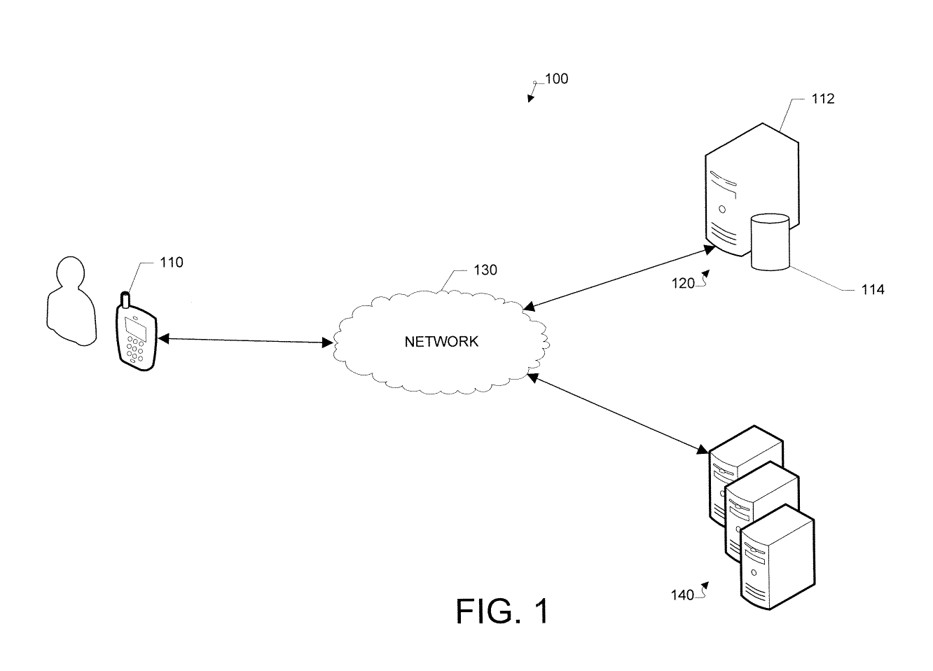

FIG. 1 illustrates an example client-server network environment, which provides for generating a native web app at a mobile device that behaves similar to a native app. The network environment 100 includes a client device 110 communicably connected to a server 120, and one or more remote servers 140 by a network 130.

In some example implementations, client device 110 can be a mobile computing device such as smartphones, PDAs, portable media players, tablet computers, or other appropriate mobile computing devices. In the example of FIG. 1, client device 110 is depicted as a smartphone. In one example, the client device 110 includes a processing device that executes computer instructions for generating a native web app that behaves similar to a native app. In one example, the processing device 110 further includes a memory for storing information regarding one or more native apps and/or web apps, and computer instructions for generating a native web app that behaves similar to a native app. In one example, the processing device may execute one or more native apps and an embedded web browser.

In some implementations, server 120 includes a processing device and data stores, for example, to facilitate managing native web app requests from client device 110. Server 120 may be in communication with remote servers (e.g., remote servers 140) or various other client devices either through the network 130 or through another network or communication means.

Remote servers 140 may host one or more web servers, native apps, app stores or other client apps or services running on the client device 110, or in connection with the server 120. Remote servers 140 may be in communication with the client device 110 or server 120 through various communication means, including network 130.

In some example aspects, server 120 and/or remote servers 140 can be a single computing device such as a computer server. In other implementations, server 120 and/or remote servers 140 can represent more than one computing device working together to perform the actions of a server computer (e.g., cloud computing). Server 120 and/or remote servers 140 may be coupled with various remote databases or storage services. It should be understood that the functions performed by the server 120 and/or remote servers 140 may be performed within a single server, or across multiple servers.

Communications between the client device 110 and server 120 and/or remote servers 140 may be facilitated through various communication protocols. In some aspects, client device 110 may communicate wirelessly through a communication interface (not shown), which may include digital signal processing circuitry where necessary. The communication interface may provide for communications under various modes or protocols, including Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, including using a Bluetooth, WiFi, or other such transceiver.

The network 130 can include, for example, any one or more of a personal area network (PAN), a local area network (LAN), a campus area network (CAN), a metropolitan area network (MAN), a wide area network (WAN), a broadband network (BBN), the Internet, and the like. Further, the network 130 can include, but is not limited to, any one or more of the following network topologies, including a bus network, a star network, a ring network, a mesh network, a star-bus network, tree or hierarchical network, and the like.

Users may interact with an app store at the electronic device 110. In one example, the user may locate and request to install a native web app through an app store (e.g., hosted by server 110 and/or one or more remote servers 140). In one example, the native web app may include a manifest file and a set of instructions. The manifest file of the native web app may include permissions for the native web app. The permissions include a permission to run the web browser at the client device in full screen mode. Upon receiving the request from the user, the manifest file is retrieved from the app store and the permissions for the native web app are provided for display to the user. Upon receiving user indication of accepting the permissions, the native web app is downloaded from the app store and installed at the client device 110.

The manifest file may further include a unique name and logo for the native web app. The native web app is installed at the client device 110 using the name and logo indicated within the manifest file. Once the user selects to launch the native web app at client device 110, the set of instructions of the native web app causes the web browser at the client device 110 to be launched in full screen mode and to display the web app (e.g., one or more web pages) associated with the URL of the native web app.

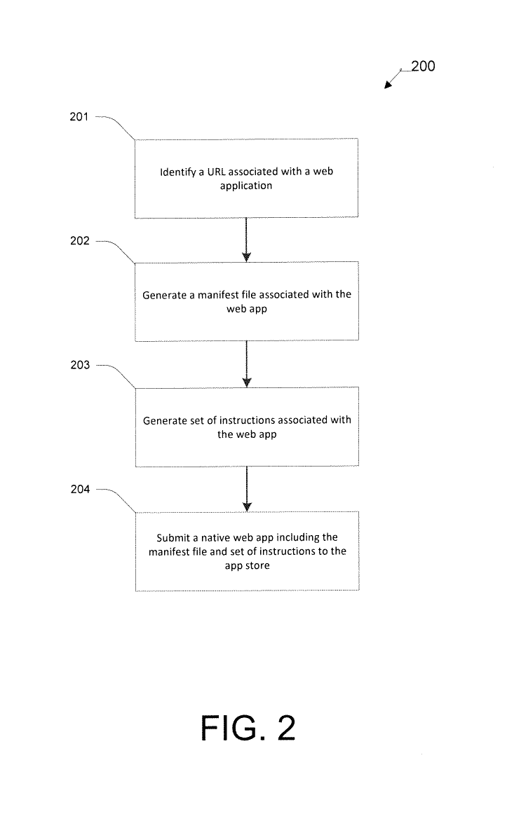

FIG. 2 illustrates a flow diagram of an example process 200 for generating a native web app. In step 201, a URL associated with a web app is identified. In one example, the URL may be associated with a home page or main page of a website providing content of a web app for display to the user.

In step 202, a manifest file associated with the web app is generated. In one example, the manifest file includes one or more permissions. The permissions, for example, may grant permissions for an app (e.g., the native web app) to gather and use information about a client mobile device of a user (e.g., the device it will be running on). This information allows the app to integrate with the device, and/or other apps running on the device. The information may for example include security information about the device (e.g., PIN, serial number, etc.), information regarding other apps running on the device (e.g., calendar, contacts, email, messenger, camera, etc.), information regarding the device surroundings (e.g., location, positioning information, etc.), and other similar information. The permissions further include a full screen browser app permission. This permission grants the web app permission to open the browser app at the mobile device (e.g., embedded and/or native) in full screen mode. In addition, a unique name and/or logo for the native web app may be specified in the manifest file. In some examples, the manifest file may further include intents to serve one or more other apps (e.g., URLs or native app calls).

In step 203, a set of instructions associated with the web app is generated. The set of instructions, in some examples, includes code for launching the URL identified in step 201, using the browser app at the device in full screen mode. In step 204, the web app made up of the manifest file and set of instructions generated in steps 202 and 203 are submitted to one or more app stores that facilitate access to the native web app (e.g., to install and launch the native web app at a user mobile device). In one example, a name and/or logo (e.g., the same name and/or logo specified in the manifest file) is specified to be displayable when the native web app is displayed within the app store or marketplace.

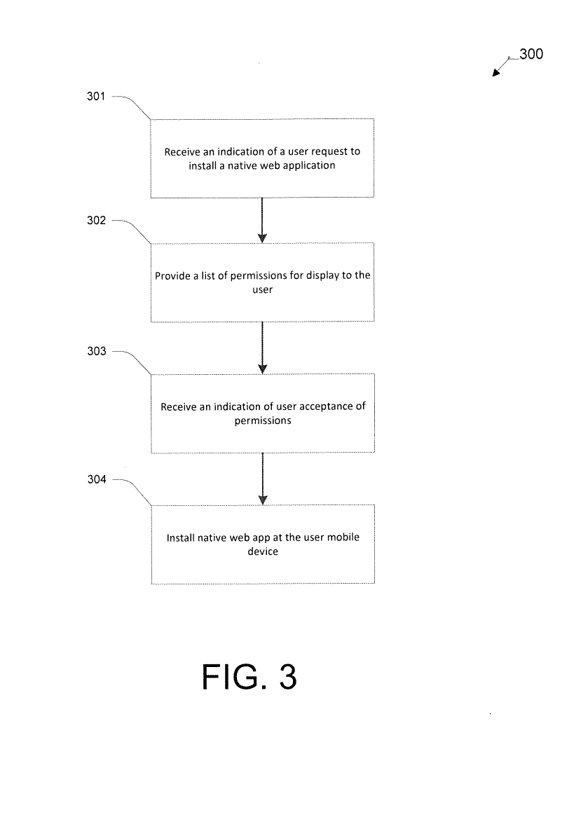

FIG. 3 illustrates a flow diagram of an example process 300 for facilitating installation of a native web app at a user mobile device. In step 301, an indication of a user request to install a native web app is received. In one example, an app store or marketplace may be accessible through the user mobile device and provide an array of native apps for installation at the user mobile device. In one example, the user may search for or otherwise locate a native web app (e.g., the native web app generated according to FIG. 2 above) from the app store. In one example, the app store accesses the native web app and provides a graphical representation of the native web app for display to the user. In one example, the native web app may be displayed using a name and/or logo specified when the native web app is submitted to the app store. In another example, the manifest file of the native web app may be accessed to determine the name and/or logo for displaying the native web app to the user within the app store. Once the native web app is displayed to the user, the user may select to install the native web app to the user mobile device. In one example, the selection may include agreeing to purchase and/or install the native web app.

In step 302, a list of permissions associated with the native web app are provided for display to the user at the mobile device. In one example, a manifest file associated with the native web app is accessed, and a list of permissions associated with the native web app are accessed and provided for display to the user. The list of permissions, in one example, includes a full screen permission for launching a browser app at the mobile device in full screen mode.

In step 303, an indication of user acceptance of the permissions listed in the list of permissions provided in step 302 are received. In one example, once the list of permissions is displayed to the user, the user may accept to grant the permissions. In one example, the user is able to select which permissions to grant from the list of permissions. In some examples, some permissions such as the full screen permission may be required permissions such that the user is required to accept the permission before the native web app may be installed at the user mobile device.

In step 304, the native web app is installed at the user mobile device. In one example, the manifest file of the web app includes information regarding the logo and/or name to be used on the mobile device when the native web app is installed. The native web app, is installed, in some implementations, in the same location as other native apps. For example, in some implementations, the app is installed at the home screen of the mobile device. In some examples, the user may launch the installed native web app and begin to interact with the content of the native web app.

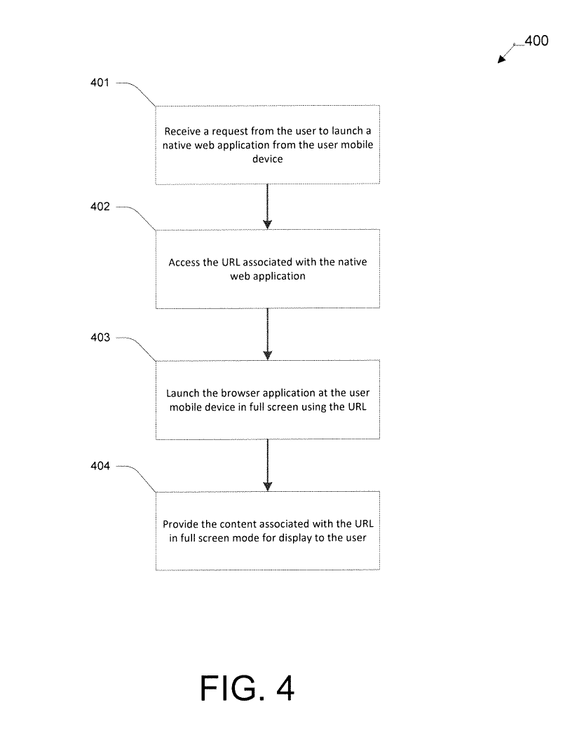

FIG. 4 illustrates a flow diagram of an example process 400 for facilitating launching a native web app at a user mobile device. In step 401, a request to launch a native web app is received at the user mobile device. For example, the request may include a user request. For example, the user may access the app installed at the main menu (e.g., a homepage) of the mobile device and select to launch the web app.

In step 402, the URL associated with the native web app is accessed and in step 403, the browser at the user mobile device is launched in full screen mode using the URL. In one example, the set of instructions of the native web app are executed. The set of instructions include a command to launch the browser app in full screen mode using the URL associated with the native web app. In some examples, the app may further be launched in response to a selection to launch the app when a URL and/or app being listed as being served by the native web app is identified.

In step 404, the content of the web app is provided for display to the user using the browser app in full screen mode. During the navigation through the website associated with the app, the experience is similar to a user using a native app, and may appear independent of the web browser (e.g., no browser window, browser icons, etc.). In one example, the content within the app may include links to or otherwise provide for navigation to additional content at one or more other external websites or webpages. In some examples, when navigating to external web pages the content may be provided for display within the full screen native web app. In other examples, the external web pages may be presented using the web browser app (e.g., by redirecting the user to the browser app).

Once the native web app is launched, an instance of the running native web app, is added to the list of native apps running on the mobile device. In one example, a unique name and logo of the native web app is displayed within the list of running apps (e.g., a logo and name specified by the manifest).

Many of the above-described features and apps are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or apps stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software app, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

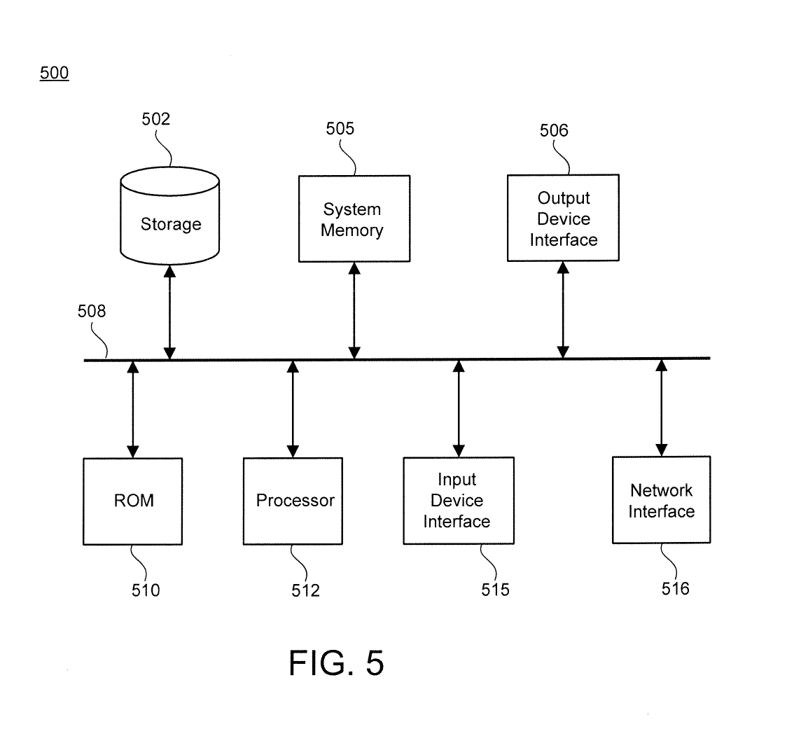

FIG. 5 conceptually illustrates an electronic system with which some implementations of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for generating a native web app according to various implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as app specific integrated circuits (ASICs) or field programmable gate arrays (FPGAs). In some implementations, such integrated circuits execute instructions that are stored on the circuit itself.

As used in this specification and any claims of this app, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this app, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an app server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A method for facilitating a native web app, the method comprising:
receiving a request from a user at a first mobile device to install a native web application (“app”) from an app store accessible at the first mobile device, the native web app providing functionality associated with a web app associated with a uniform resource locator (“URL”), wherein the web app provides a set of content displayable by a browser app at a user mobile device;
accessing the native web app, the native web app including:
a manifest file including a set of permissions, the permissions including a permission for displaying a browser app in full screen mode; and
a set of instructions including instructions for launching a browser app at the first mobile device in full screen mode using the URL;
providing the set of permissions for display to the user in response to the request;
receiving an acceptance of one or more permissions of the set of permissions from the user; and
installing the native web app on the first mobile device in response to receiving the acceptance.

2. The method of claim 1, further comprising:
generating the manifest file and the set of instructions; and
providing the manifest file and set of instructions as the native web app within the app store accessible at a user mobile device.

3. The method of claim 1, wherein the manifest file further includes a unique name and logo associated with the native web app.

4. The method of claim 1, wherein the manifest file further includes a listing of intents, the listing specifying one or more web pages or apps served by the native web app.

5. The method of claim 1, further comprising:
displaying an icon associated with the native web app at the first mobile device in response to installing the native web app.

6. The method of claim 5, wherein the icon comprises one or both a name or logo associated with the native web app according to the manifest file.

7. The method of claim 1, wherein the native web app is installed in the same location as one or more native apps.

8. The method of claim 1, further comprising:
receiving a request at the first mobile device to launch the native web app installed at the first mobile device;
launching the native web app in response to the request.

9. The method of claim 8, wherein launching the native web app comprises launching a browser app at the first mobile device in full screen mode using the URL associated with the native web app.

10. The method of claim 8, wherein launching the native web app comprises executing the set of instructions.

11. The method of claim 8, wherein the request comprises a request from a user at the mobile device.

12. The method of claim 8, wherein the request comprises a request to serve an app being served by the native web app.

13. The method of claim 8, further comprising:
adding the native web app to a list of running apps at the first mobile device in response to launching the native web app according to the manifest file.

14. The method of claim 8, wherein launching the native web app causes the content of the web app to be displayed to the user in full screen mode.

15. A system for facilitating a native web app, the system comprising:
one or more processors; and
a machine-readable medium comprising instructions stored therein, which when executed by the processors, cause the processors to perform operations comprising:
receiving a request from a user at a first mobile device to install a native web application (“app”) from an app store accessible at the first mobile device, the app store providing a plurality of native apps for one or more mobile devices, the native web app providing functionality associated with a web app providing a set of content displayable by a browser app;
accessing the native web app, the native web app including:
a manifest file including a set of permissions, the permissions including a permission for displaying a browser app in full screen mode; and
a set of instructions including instructions for launching a browser app at the first mobile device in full screen mode using a uniform resource locator (“URL”) associated with the web app;
providing the set of permissions for display to the user in response to the request;
receiving an acceptance of the permission for displaying the browser app in full screen mode;
installing the native web app on the first mobile device in response to receiving the acceptance; and
displaying an icon associated with the native web app on the first mobile device in response to installing the native web app.

16. The system of claim 15, the operations further comprising:
generating the manifest file and the set of instructions; and
submitting the native web app to one or more app stores including the app store, each of the one or more app stores providing a plurality of native apps for one or more mobile devices.

17. The system of claim 15, the operations further comprising:
receiving a request at the first mobile device to launch the native web app installed at the mobile device;
launching the native web app in response to the request, wherein launching the native web app comprises executing the set of instructions to cause launching a browser app at the mobile device in full screen mode using the URL.

18. A machine-readable medium comprising instructions stored therein, which when executed by a machine, cause the machine to perform operations comprising:
receiving a request from a user at a first mobile device to install a native web application (“app”) from an app store accessible at the first mobile device, the app store providing a plurality of native apps for one or more mobile devices, the native web app providing functionality associated with a web app providing a set of content displayable by a browser app;
accessing the native app, the native web app comprising:
a manifest file including a set of permissions, the permissions including a permission for displaying a browser app at a mobile device in full screen mode; and
a set of instructions including instructions for launching a browser app in full screen mode using a uniform resource locator (“URL”) associated with the web app;
providing the set of permissions for display to the user in response to the request; and
installing the native web app on the first mobile device.

19. The machine-readable medium of claim 18, the operations further comprising:
generating the manifest file and the set of instructions; and
submitting the native web app to one or more app stores including the app store, the one or more app stores each providing a plurality of native apps for one or more mobile devices.

20. The machine-readable medium of claim 18, the operations further comprising:
receiving a request at the first mobile device to launch the installed native web app; and
launching the native web app in response to the request, wherein launching the native web app comprises executing the set of instructions to cause launching a browser app at the first mobile device in full screen mode using the URL.
